(19) United States
(12) Patent Application Publication
(10) Pub. No.: US 2008/0159571 A1
(43) Pub. Date: Jul. 3, 2008

(54) Miniature Surround-Sound Loudspeaker

(75) Inventor: Anthony Hooley, Cambridge (GB)

Correspondence Address: HARNESS, DICKEY & PIERCE, P.L.C., P.O. BOX 828, BLOOMFIELD HILLS, MI, 48303, US

(73) Assignee: 1...LIMITED, Cambridge (GB)

(21) Appl. No.: 11/632,438

(22) PCT Filed: Jul. 12, 2005
(86) PCT No.: PCT/GB2005/002720

§ 371 Date: Aug. 14, 2007

(30) Foreign Application Priority Data
Jul. 13, 2004 (GB) 0415625.3

(51) Int. Cl. H04R 1/40; H04S 5/00; G10K 11/34; H04B 11/00; G10K 15/02

(52) U.S. Cl. 381/307; 381/77; 381/79

(57) ABSTRACT

A portable sound system for use in portable devices such as laptops or mobile phones is described using the principles of parametric sound generation to create a virtual headphone-like system using focusable and steerage beams of ultrasonic sound emitted from a portage phased array or similar source of ultrasonic sound beams, focused at the vicinity of the left and right ear of the user. The system being also capable of producing audible surround sound and adapted to compensate for head motion through use of an optical based tracking system.

The present invention relates to a small portable speaker system capable of generating highly localised sound. More specifically, the invention relates to a novel way of substituting headphones for portable applications and of providing portable surround sound systems.

### BACKGROUND OF THE INVENTION

Parametric (array) loudspeakers are known in the art (see e.g. Laurence Kinsler, Fundamentals of Acoustics 4^{th} Edition, Wiley, 2000, ISBN 0-471-84789-5, pp. 488-491), wherein columns of ultrasound, generally radiated by a large-area (compared to wavelength scale) transducer or array of small transducer elements (the Transmitter), are caused to interact non-linearly with a surrounding fluid in which the sound propagates. If it is arranged that more than one ultrasonic frequency is radiated simultaneously from the Transmitter, at suitably high levels, then the fluid non-linearity causes mixing of the transmitted frequencies and sidebands to be created related to the sum and difference frequencies of the transmitted frequencies. Where the difference frequency(s) is/are below ˜20 KHz, audible sound may be generated in the fluid, though none was radiated by the Transmitter. It is necessary, for significant audible output level to be produced, for the ultrasonic levels to be high enough to make the fluid significantly non-linear, and ultrasonic SPLs of more than 100 dB are generally used, up to much higher levels. Because there is an inherent non-linearity in the process of creating the audible sound from a parametric loudspeaker, several schemes are known in the art for reducing this distortion, and these generally work by pre-distorting the drive signals to the Transmitter to partially compensate for the fluid non-linearity induced distortions.

Head Related Transfer Functions (HRTF), which are descriptions of the varying frequency/phase/time-delay response of a human's ears with direction of incidence of sound from the far-field, are well known in the art, as also are methods of utilising knowledge of HRTFs to provide pseudo-surround-sound effects to a listener. In this methodology, different signals (usually between 2 and 5 but more are possible) intended to be perceived by the listener as having arrived from different angles of incidence, are pre-filtered with the appropriate different HRTF plus some (same) optional delivery-transfer-function (to compensate for the actual angle of delivery of the sound to the user's ear(s)) before conversion to acoustic signals, and the sum of all such pre-filtered channel signals are then delivered to the user's ears often via headphones (guaranteeing excellent left/right separation), or via two loudspeakers some distance from the listener whence the left/right separation is much less in which latter case further additional processing is often done to minimise perceived crosstalk between the left and right composite signals. In the latter loudspeaker delivery, crosstalk cancellation schemes, the surround-sound effect achievable is not generally as good as when headphones are used, because some residual crosstalk is inevitable.

Phased array antennas are also known in the art, primarily in the microwave electromagnetic spectrum, but also in the acoustic sonic and ultrasonic spectrum. Focusable (as opposed to merely steerable) phased array antennas are also known, see e.g. the co-owned published international patent application number WO0123104. Multi-beam (simultaneous) focused phased array acoustic antennas are also well known in the art and are described in the same co-owned patent.

It is known in the art to direct and focus ultrasound beams emitted by a parametric loudspeaker by mechanically moving each of the individual elements of an array of emitters such that the array takes on a suitable overall concave shape, as described in U.S. Pat. No. 4,823,908, Tanaka et al. Such a device is cumbersome as it requires a physical mechanism to move each of the emitters, of which there may be several tens, and is therefore only suitable for stationary applications (i.e. not portable). As described, the device is set up by manually adjusting the position of each emitter, an operation which clearly cannot be carried out quickly or dynamically in response to changing requirements, for example, a change in the location of the listener.

It is also known in the art to produce directed ultrasonic beams from a parametric loudspeaker by changing the phase relationships between emitters in an array, as described in U.S. Pat. No. 6,577,738, Norris et al. The system as described emits parallel sided beams in selected directions such that audio sound is generated everywhere along the beam, as is normal in parametric loudspeakers. Such an electronically steered phased array system allows real-time selection of the direction of the beam.

It is farther known in the art to direct a number of such electronically steered beams from a number of phased arrays such that the individual parallel-sided beams converge to a point, as described in U.S. Pat. No. 6,580,374, Schrage et al. In a parametric loudspeaker of this type, the convergence of ultrasound energy at a point causes generation of audible sound at that point. Such a system requires an array of phased arrays and is necessarily quite large and therefore unlikely to be suitable for portable applications.

In the light of the known art, it is an object of the present invention to provide a small device, e.g. a portable telephone, to produce sound, including the possibility of multi-channel surround sound, that is ideally heard only by the phone user, without the use of headphones which are generally not very portable nor convenient, however with similar sound and optionally surround sound performance and low crosstalk as is normally associated with headphone delivery sound and HRTF surround-sound systems.

### SUMMARY OF THE INVENTION

In the known parametric loudspeaker art, the transmission antennas are generally planar, and in any case are designed to produce approximately parallel sided ultrasonic sound beams, which eventually decay with distance because of the significant absorption of ultrasound energy by air, water or most real fluids. Because of this the Sound Pressure Level (SPL) everywhere within the sound beam has to be adequately high (and generally >>100 dB) in order that useful nonlinear fluid effects will occur and result in sonic sound generation.

In the first aspect of the invention the known parametric loudspeaker transmission antenna is modified, so that it produces from a portable array or antenna a beam of ultrasound focused at a specified (and possibly variable) distance from the antenna. It is thus an aspect of the present invention to provide a compact parametric loudspeaker suitable for portable applications. The parametric loudspeaker comprises a phased array of ultrasonic emitters arranged to emit a beam of ultrasonic energy which is both directed and focused. That is, the beam is not parallel-sided but focused and the direction and distance of focus are electronically controllable.

The portable array or antenna is either implemented using a curved radiator (e.g. a spherical or paraboloidal section), or, more preferably by using some kind of phased array antenna which is electronically steerable and focusable.

When this focusing is done, several benefits accrue. The ultrasound energy will be highly concentrated at the focal “point” (actually a small region around the geometric focal point of dimensions comparable to the wavelength of the ultrasound) relative to everywhere else, and so non-linearity effects in this focus region will be much stronger than elsewhere (stronger even than adjacent to the antenna where the SPL might be relatively much smaller). As the amplitude of the sonic sound produced by the non-linearity is proportional to the square of the amplitude of the ultrasound beams, it is clear that such sonic sound will preferentially be produced directly in the region of the focus and much less elsewhere, and in particular, the sonic sound will not be of comparable loudness further away from the transmitter along the direction of the beam, as is the case for the known parametric loudspeakers. So the first aspect of the invention is a focused parametric loudspeaker with improved parametric sound generation highly localised around the focal point.

In a preferred embodiment of the first aspect, the region of focus is located close to the head of a listener and, even more preferably, close to at least one ear of a listener. The parametric loudspeaker antenna sizes and the ultrasonic wavelengths used are preferably chosen such that the focused beam sizes are of a small extent comparable in size to the user's ear aperture or as close to that size as is practicable.

In the second aspect of the invention a first focused parametric loudspeaker is arranged to project a beam of ultrasound that is directed towards and focused on or very close to the left ear of the user of the device (hereafter, the “user”). A second parametric loudspeaker is similarly arranged to project and focus a beam of ultrasound on or very close to the right ear of the user. The amplitude of the ultrasonic beams in the vicinity of the user's ears is arranged to be sufficiently high that non-linear acoustic effects occur here, as is known in the parametric loudspeaker art. It will be seen that such a device is able to deliver two channels of sound, one to each ear of the user, with very little crosstalk between the perceived channels, similar to the manner achieved with headphones, and without physical contact between the device and the user.

The signals used to drive the first and second parametric loudspeakers are suitably pre-distorted to compensate for the non-linearity of the parametric loudspeakers, as known in the parametric loudspeaker art.

Where it is desired to provide surround sound to the user, then the signals used to drive the first and second parametric loudspeakers are adapted in accordance with the signal processing as known in the HRTF/pseudo-surround-sound art for delivering virtual/pseudo surround sound via headphones in addition to the parametric loudspeaker pre-distortion or distortion compensation as mentioned before.

It is an advantage of this second aspect of the invention to deliver very locally to the ears of the user, without the use of headphones and remotely from the transmitting device, sounds that the user will perceive as two channel or fall surround-sound, with very little crosstalk from left to right ears and vice versa, due to the highly localised parametric conversion to sonic sound occurring in the immediate vicinity of the user's ears. So the second aspect of the invention is a small non-contact two channel or HRTF-based multichannel-surround-sound delivery system implemented with two focused parametric loudspeakers.

In the third aspect of the invention, one ultrasonic transmission antenna, of phased array design, is used to simultaneously transmit two or more separately directed and separately focused beams of ultrasound.

When combining the second aspect of the invention with this third aspect the two beams respectively focused at the left and right ear of the user can be generated by a single antenna instead of being transmitted by two distinct transmission antennas or parametric loudspeakers. In this variant of the invention the performance and function are identical to that of the second aspect, with however one single dual-beam focused phased array parametric loudspeaker which produces the two distinct (left-ear and right-ear) ultrasound beams that generate localised low-crosstalk sonic sound at the user's ears.

In a preferred variant of the invention, a tracking system is provided which supplies a target position coordinates to the steerable focused parametric loudspeaker(s) of the present invention, in such a way that the parametric loudspeaker ultrasound beam focus points track the position of the target even when the user moves relative to the parametric loudspeaker.

In a preferred embodiment the tracking system locks onto the ear position of the user, so that the user continues to hear the left and right sound channels in the left and right ears, with low crosstalk, or the HRTF induced surround sound. Thus, a preferred embodiment of this variant of the invention can be described as a two beam, one antenna, ear-tracking focused parametric loudspeaker for the delivery of two channel or HRTF surround-sound.

Preferably, the tracking system compensates for a given range of user head movements. For example if one or both ears are no longer in straight unobstructed line from the transmitter(s) the compensation system may provide alternative focal points or switch off one channel. Variations in the distance of the ears from the transmitter(s) can be compensated for by adapting for example the intensity or ultrasonic SPL at the focus points adjacent to the ears to generate sufficient sonic SPL for different distances.

In yet another aspect of the invention, a portable computer, or communication device such as a telephone, is the platform on which is mounted any of the preceding aspects of the invention, and which provides the dc supply power, and signal sources and/or signal processing capabilities to create the two or more channel sound signals to be delivered to the ears of the user.

In a variant of this aspect of the invention, the platform is fitted with a camera and image processing software providing at least part of a tracking system as described above. The software analyses the camera captured images when the camera is facing the user of the device, and determines from those camera images the location of the head of the user, and from that either deduces the ear positions, or further image analysis is used to measure the ear positions or the general head orientation for subsequent deduction of the ear position, if the latter cannot be directly tracked

### BRIEF DESCRIPTION OF THE DRAWINGS

FIG. 1 shows a focused parametric loudspeaker for use in the present invention; and

FIG. 2 shows a focused parametric loudspeaker for use as two-channel or surround sound system.

### DETAILED DESCRIPTION

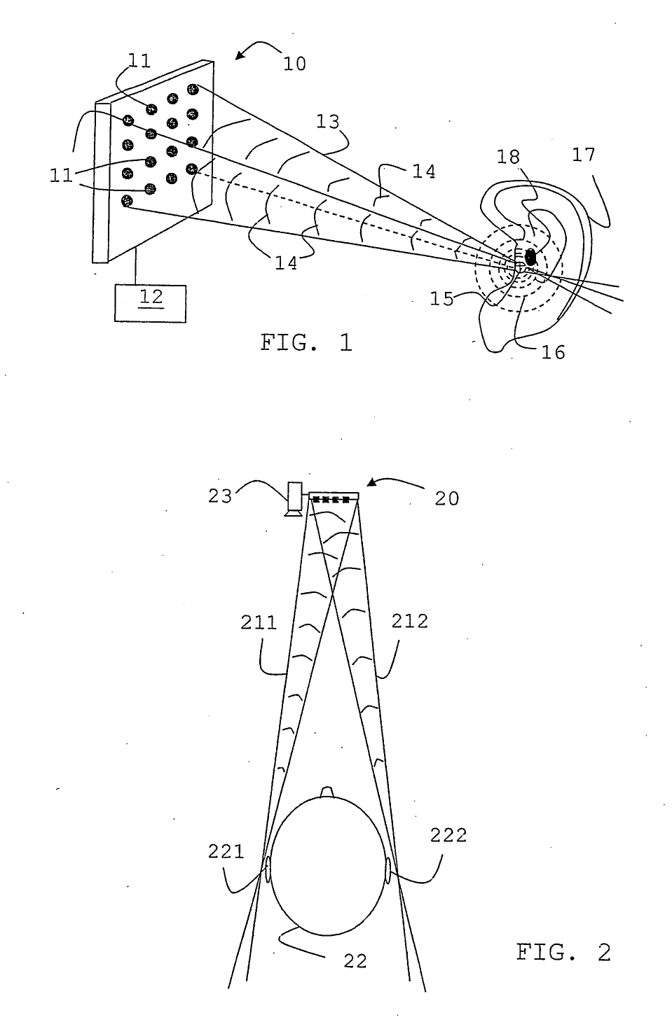

FIG. 1 shows a focused parametric loudspeaker of the invention. The parametric loudspeaker 10 comprises a small portable planar array of ultrasonic emitters 11, in this case a 4 by 4 array. Each emitter 11 is a piezoelectric transducer suitable for emitting high frequency ultrasonic energy, each independently controllable by control electronics (not shown). The emissions of the transducers are relatively time-delayed by the control electronics 12 to produce a focusing beam 13, shown with indicative concave wavefronts 14.

Even though the “beam” 13 is shown as one beam, as with all parametric loudspeakers however, in fact audible sound is generated by the non-linear interaction of two or more ultrasonic beams of different ultrasonic frequencies at least one of which is further modulated by the desired and possibly preprocessed audio signal, sharing the same volume of air at least at the position of non-linear interaction. Hence an ultrasonic beam is to be understood as at least two ultrasonic beams with frequencies and modulation as described. Unlike conventional parametric loudspeakers, the acoustic energy or intensity in the beam 13 is not necessarily sufficient over most of its path to interact non-linearly with the air and produce audible sound. However, at and near the point of focus 15 of the beam 13, the energy density and acoustic intensity is at a maximum and audible sound is generated. The audible sound radiates outwards, as indicated by the dashed wavefronts 16.

In operation, the ultrasonic beam 13 from the parametric loudspeaker 10 is arranged to focus close to the ear 17 of a listener, preferably close to the opening 18 of the ear canal. With sufficient transmitter antenna extent, the diameter of the volume of focus is of the order of an ultrasonic wavelength, for example about 7 mm for a frequency of 50 kHz, and the ultrasonic beam either hits the ear or at least passes within about 10 to 50 mm of the ear.

For adequate perception of audible sound, the sound pressure level (SPL) in the vicinity of the ear needs to be about 10-20 dB greater than the ambient SPL, which is typically about 40 dB in a quiet room and 60-70 dB in an office. Thus an SPL of around 80-85 dB is sufficient in many applications. For comparison, in a conventional (non-focusing) parametric loudspeaker, such as the HSS Directed Audio Sound System supplied by American Technology Corporation, an audible SPL of 85 dB at 2 metres from the emitter array is achieved from an emitter of radiating area 280×280 mm with a power consumption of 90-240 W operating at 48 kHz (see HSS Directed Audio Sound System, User's Manual).

Using the above figures for the conventional parametric loudspeaker, the areal power density in the beam at the listener position is similar to that at the emitter, since the beam divergence is small (and ignoring transmission losses in the air, and transmitter efficiency in the first instance), that is 240/(280×280) W mm⁻²=3 mW mm⁻². In the focused speaker of the invention, the area of the focused beam is about 49 mm² (7 mm×7 mm) assuming the same operating frequency of 48 kHz and hence wavelength 7 mm, the focused “spot” size being of the order of a wavelength. To achieve a similar power density to that in the beam of a conventional parametric speaker (3 mW mm⁻²), a power of 147 mW (3 mW mm⁻²×49 mm²) is required. Again ignoring air losses and transmitter efficiency in the first instance, a focused parametric speaker operating at about 150 mW is thus able to achieve sufficient ultrasonic power density at the ear to generate audible sound. Such a power level is readily provided by a battery in a portable device such as a mobile phone.

For portable applications, a relatively small array 10 size is desirable. The face of a mobile phone typically measures about 50 mm×100 mm, or double that if the phone has a flip cover. It would be difficult to accommodate an emitter array size of much more than say 50 mm by 50 mm (area 2500 mm²). According to well known array design principles, to ensure very tight beam directivity the extent of an emitter antenna needs to be more than about ten wavelengths. With an array extent of 50 mm suitable for a mobile phone, a wavelength of about 5 mm is implied to achieve this approximate criterion, corresponding to an ultrasonic frequency of 70 kHz. Array design principles also require a transducer separation, and hence transducer size, of less than about half a wavelength, or about 2.5 mm in this instance if alias beams (full power sidelobes) are to be avoided. This would result in an array of 20×20 transducers, 400 in total, which large number is known to provide excellent beam shaping. At 70 kHz, the size of the focused spot is about 5 mm and the operating power to achieve the power density noted above is about 70 mW. Thus the higher operating frequency of 70 kHz compared to 48 kHz in the first example given above gives the benefits of smaller array extent, more tightly focused beam and considerably reduced power consumption. Transmission losses in the air increase with frequency, but for hand-held portable applications the path length is anyway short, of the order of 500 mm or less, such that losses are minimal and not an issue.

FIG. 2 illustrates as a schematic view from above a further embodiment of the invention in which a parametric loudspeaker 20 produces two ultrasound focused beams 211, 212, directed either side of the user's head 22 and focused in the vicinity of the user's ears 221, 222. The two ultrasonic beams are emitted simultaneously by the same transducer array 20 but carry different audio signals, for example the left and right channels of a stereo signal. The emitter array 20 may be housed in a hand-held portable device such as a mobile phone for example. In this case, the emitter array is of a suitable size to fit into a mobile phone, of the order of tens of millimetres in extent, for example 50 mm in width and height. When the mobile phone is used in hand-held mode, its distance from the user's ears is typically some hundreds of millimetres, say 300-600 mm.

The two ultrasonic beams 211, 212 generate two audio signals, one for the right ear and one for the left. The device may be set to operate in a number of different modes, the settings being user-selectable. In a first mode, the audio signal is the same in the two beams 211, 212, 211, 212 generate the right and left channels of stereo sound. In a third mode, the signals are processed with a Head Related Transfer Function (HRTF) to give the user the impression that the sound emanates from directions other than the front. In this mode, surround sound can be simulated. A miniature camera 23 is shown to monitor the movements of the head 22 in order allow the system to steers the ultrasonic beams 211, 213.

1. Portable sound system, comprising one or more ultrasonic antennae adapted to generate at least one focused beam of ultrasonic sound, with parametric sound generation being highly localised around the focal point.

2. The portable sound system of claim 1, adapted to generate two or more focused beams of ultrasonic sound.

3. The portable sound system of claim 1, wherein the antenna is an electronically steerable phased array.

4. The portable sound system of claim 1, wherein the at least one focused beam is in operation focused at a focal point in the immediate vicinity of a user's ear.

5. The portable sound system of claim 4, adapted to generate two focused beams being in operation focused simultaneously at focal points in the immediate vicinity of a user's left and right ear respectively.

6. The portable sound system of claim 1, wherein the drive signal for the one or more ultrasonic antennae is pre-distorted to compensate for the non-linear effects of parametric sound generation.

7. The portable sound system of claim 6, wherein the drive signal for the one or more ultrasonic antennae is processed as determined by a Head Related Transfer Function (HRTF).

8. The portable sound system of claim 7, wherein the drive signal for the one or more ultrasonic antennae is processed as determined by a Head Related Transfer Function (HRTF) to provide a surround sound effect.

9. The portable sound system of claim 1, further comprising a tracking system adapted to determine a focal point of a focused beam in dependence on the motion of a user's head.

10. The portable sound system of claim 9, wherein the tracking system comprises a camera and an image recognition system.

11. A portable device comprising a portable sound system in accordance with claim 1.

12. A method of generating two or more sound channels, said method comprising: focusing at focal points in the vicinity of a user's left and right ear, respectively, focused beams of ultrasonic sound at sufficiently high intensity to generate a non-linear sound mixing and using said mixing to create audible sound emanating from the focal points.

13. The method of claim 12, using an electronically steerable phased array as antenna for the ultrasonic sound.

14. The method of claim 12, comprising the step of pre-distorting the ultrasonic beams to compensate for the non-linear effects of parametric sound generation.

15. The method of claim 12, wherein a Head Related Transfer Function is used to generate a surround sound effect.

16. The method of claim 12, wherein a tracking system is used to determine a focal point of a focused beam in dependence of the motion on a user's head.
